(19) United States
(12) Patent Application Publication
(10) Pub. No.: US 2005/0286549 A1
(43) Pub. Date: Dec. 29, 2005

(54) Secured peer-to-peer wireless telecommunications apparatus and method

(76) Inventor: Frederick J. Murphy, Falmouth, MA (US)

Correspondence Address: LESLIE MEYER-LEON, ESQ.;IP LEGAL STRATEGIES GROUP P.C., 1480 FALMOUTH ROAD, P.O. BOX 1210, CENTERVILLE, MA, 02632-1210, US

(21) Appl. No.: 10/873,639

(22) Filed: Jun. 23, 2004

(51) Int. Cl. H04L 12/66

(52) U.S. Cl. 370/463; 370/352

(57) ABSTRACT

An Apparatus and Method for Securely Transmitting and Receiving Voice and Data Peer-to-Peer Over Wireless Telecommunication Networks is Shown. In One Embodiment of the Invention a First Wireless Device is Connected to a Standard Telephone Hand Set via an RJ 11 Wireline Connector. Said Device Generates Correct Dial Tone; Receives Analog Telephony Signals; Converts the Analog Signals Into Voice Over Internet Protocol Packets (VOIP); Compresses the Packets; Encrypts the Compressed Packets, determines available and optimal wireless frequency protocols and Transmits Said Compressed/Encrypted Packets Over a Wide Fidelity Wireless Network to a Second Like Wireless Device Connected to A Standard Telephone Hand Set via an RJ 11 Wireline Connector Which Decrypts the VOIP Packets; Decompresses the Packets and Transforms the Decrypted/Decompressed VOIP Packets Back Into Analog Telephony Signals and Sends the Signals to a Connected Standard Telephone Handset.

### CROSS-REFERENCE TO RELATED APPLICATION

This application claims priority to U.S. Provisional Application entitled “Secure Peer Wireless Telecommunication Apparatus And Method” filed on Jun. 24, 2003 in the name of Frederick J. Murphy.

### BACKGROUND OF THE INVENTION

The present invention is generally directed to the field of telecommunications and more particularly, is directed to securing Voice over Internet Protocol (VoIP) wireless and wireline telecommunication traffic.

Legacy telecommunications networks and customer premise equipment transmit and receive analog telephony signals to and from a telephone company's central office switches. While unauthorized interception of telephony traffic over such legacy networks is possible, it most often requires a physical tapping into the transmission lines or compromise of a telephone company's switching stations to accomplish.

With the recent and continued migration of voice telephony traffic from analog switched to packet switched networks, unauthorized interception of the Voice Packets is much easier to accomplish than within the legacy telephone system. Further, as wireless transport layers such as 802.11—so called wi-fi, 802.16—so called WIMAX and 600-800 MHz—so called broadcast white space, become ubiquitous the privacy of a person's VoIP phone calls over such transport layers is further imperiled, by wireless packet sniffers for example which are easily obtained.

Accordingly, there is a need in the art for a more secure method and apparatus for traffic over a packet switched network.

### SUMMARY OF THE INVENTION

The present invention transforms analog speech signals received from a standard POTS phone into Voice over Internet Protocol Packets. The transformed packets are compressed and encrypts in real time via ASIC and/or SOC firmware. The method and apparatus of the present invention then determines via hardware and software the available and optimal wireless transmission protocols and frequencies within the device's zone of reception and transmits the transformed encrypted voice packets to the available and optimal remote antenna radio.

### BRIEF DESCRIPTION OF THE DRAWINGS

FIG. 1 is an illustration of one embodiment of the present invention showing first and second telephone stations;

FIG. 2 illustrates a packet switch connected to an antenna array in accordance with the present invention;

FIGS. 3 and 4 illustrate the present invention coupled to various computer networks;

FIG. 5 is a mechanical block diagram of the transform device accordance with the present invention; and

FIG. 6 is a further embodiment of the present invention.

### BRIEF DESCRIPTION OF THE PREFERRED EMBODIMENT

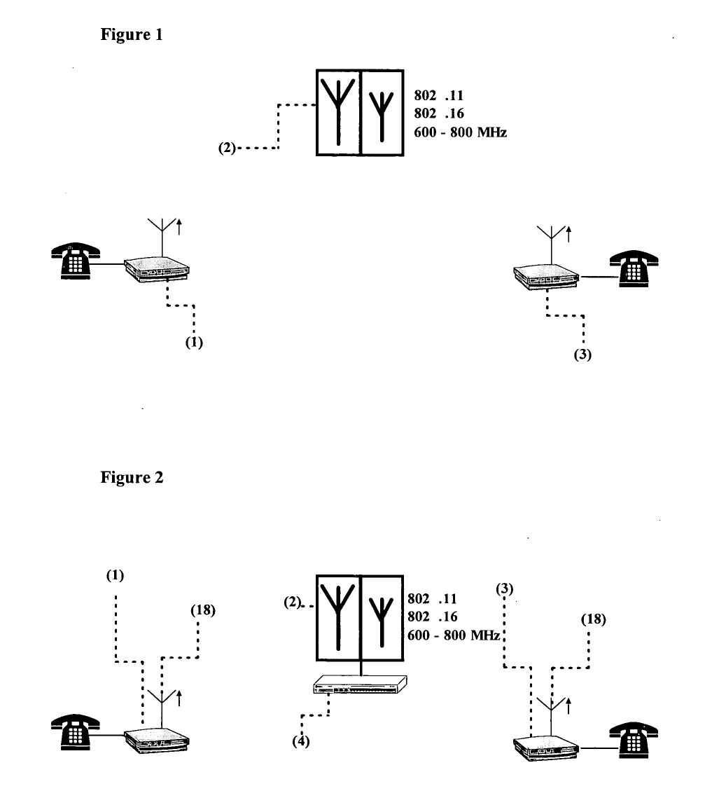

A preferred embodiment of the present invention is illustrated in FIG. 1. In this embodiment, a first wireless device 1 is connected to a standard telephone hand set via an RJ 11 wireline connector. Wireless device 1 generates a correct dial tone; receives analog telephony signals; converts via hardware and software the analog signals into voice over internet protocol packets (VOIP); compresses the packets; encrypts the compressed packets and transmits, via a radio frequency transceiver (RFT), the telephony VoIP packets to a remote radio antenna base station 2 which relays the VoIP packets to a second wireless device 3 that is within the remote radio antennas zone of influence. The second wireless device 3 is likewise connected to a standard telephone hand set via an RJ 11 wireline connector. The second device decrypts the VOIP packets; decompresses the packets and transforms the decrypted/decompressed VOIP Packets back into analog telephony signals and sends the signal to the connected standard telephone handset in full duplex VoIP.

The present invention can include any number of connected devices.

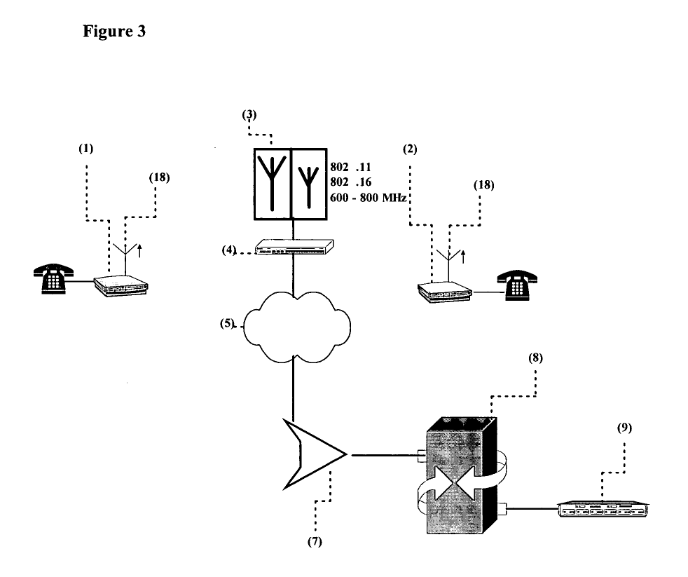

In accordance with the present invention, FIG. 2 illustrates a packet switch 4 resident with a remote external wide fidelity radio antenna broadcast/reception access point 2 and the device's antennas and transceivers are specifically engineered to RF specifications to help reduce signal attenuation, jitter and packet loss. The inter-connections between the analog to VoIP transform devices 1 and 3 via packet switch 4 are full duplex VoIP.

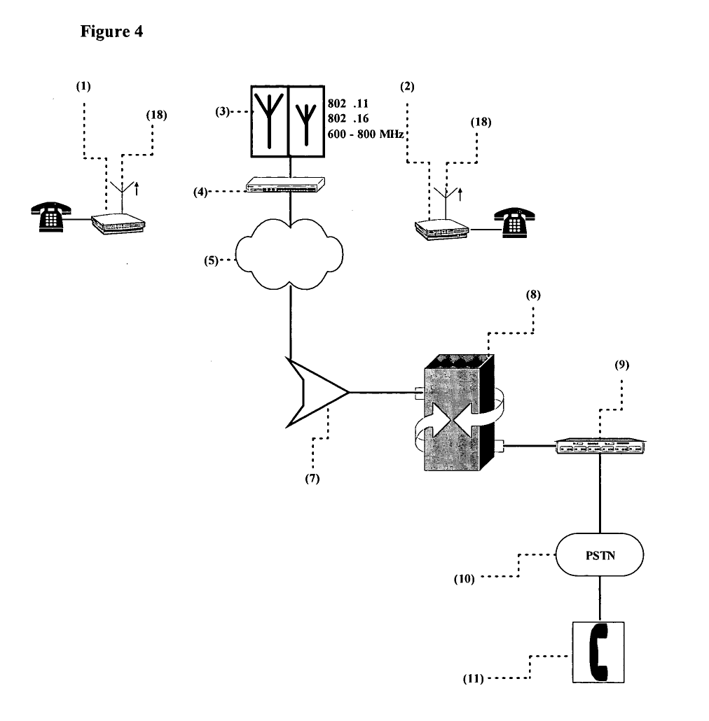

FIG. 3 illustrates the invention connected to a packet switched network such as the Internet 5, a synchronous optical network 7, and a network operations center 8 connected to a Voice Over Internet Protocol (VOIP) softswitch 9. In this configuration, full duplex VoIP teleconferencing and VoIP PBX can be readily achieved.

As in FIG. 4, the apparatus of the present invention is connected to a public switched telephone network 10 that is connected to local and long distance telephones 11.

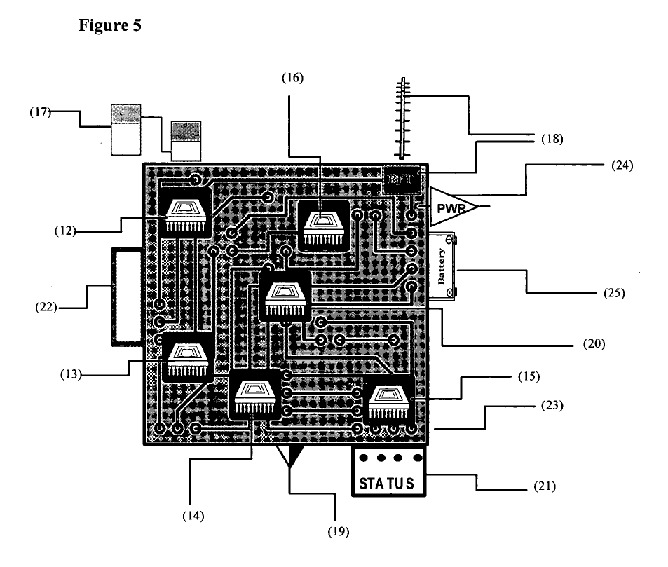

FIG. 5 is a mechanical block diagram of the construction of the transform device of the present invention. The device includes:

CPU/RTOS device 12;

DSP/LTG device 13;

Encryption/Decryption SOC/ASIC device 14;

Volatile/Non Volatile Memory device 15

CODEC(s) device 16;

I/O Broadband Communication Connectors Such as RJ 45-USB-Cable-Sat, etc. device 17;

External and/or Internal Antenna and/or Universal Antenna Connector and RF Transceiver Tunable via Physical Design and Embedded or Off Chip Circuitry to a Variety of External Radio Antennas and RF Frequency Spectrums as generally represented by reference number 18;

Telephony/Data Port device 19;

SOC/ASIC to include but not limited to GPS and Biometric System Integration device 20;

LED Systems and Signal Status Indicators devices 21;

LCD Screen and Circuitry devices 22;

PC Board-Data Bus and other Circuitry, Software Cores and Instruction Sets Necessary for the Device Functions devices 23;

DC Power Supply devices 24;

Rechargeable or disposable battery(s) 25;

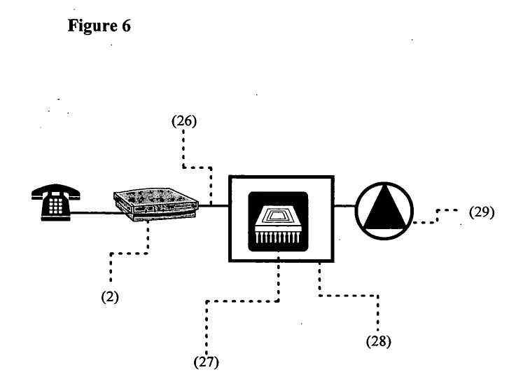

As further shown in FIG. 6, an analog to VoIP conversion device 2 is connected via a CATV cable 26 to a SOC/ASIC 27; contained within a dongle form factor 28; the SOC/ASIC containing encryption/decryption firmware 14, connected to a VoIP enabled CATV head end termination point 29.

The present invention may be implemented in hardware architecture(s) to system(s) on a chip (SOC's) and/or application specific integrated circuits ASIC(s) form(s) and/or software cores both with and without memory modules in order to embed the invention in a myriad of stand alone and integrated form factors to include, but not limited to: wireless analog and digital telephone base stations and handsets; PDA's; lap top computers, cellular phones; wireless kiosks; integrated mobile telephony automotive devices etc. It is also an objective of the present invention to send and receive VoIP packets to and from any VoIP enabled network transport means, to connect to any Broadband Network via a variety of I/O connectors and to make and receive telephone calls to and from any Public Switched Telephone Network.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

1) An apparatus and method for securely connecting standard POTS phones peer-to-peer over a wireless telecommunication network said apparatus and method comprising;
A signal recognition means; coupled to a signal discrimination means; coupled to a central office switch dial tone emulation/generation means; coupled to an analog signal to digital conversions means; coupled to a compression/decompression means; coupled to an ASIC and/or SOC encryption/decryption firmware means; coupled to a unique identity means; coupled to a wireless protocol transmission means; coupled to a network protocol encapsulation means; coupled to a wireless transceiver coupled to an antenna.

2) Wherein claim 1 the digital formatting conversion means is accomplished by a DSP coupled to Voice Over Internet Protocol stacks, which include but are not limited to network protocol encapsulation via TCP/IP/UDP and RTP.

3) Wherein claim 1 the Unique Identity Means are the devices unique MAC Addresses.

4) Wherein claim 1 the Unique Identity Means are the devices unique SIP identities.

5) Wherein claim 1 the Unique Identity Means are the devices unique NAT Addresses.

6) Wherein claim 1 the Unique Identity Means are obtained from the devices unique identity chip sets.

7) Wherein claim 1 the Unique Identity Means are the devices unique terrestrial coordinates.

8) Wherein claim 1 the Unique Identity Means are unique biometrics.

9) Wherein claim 1 the Unique Identity Means is the Quantum Entanglement of the devices.

10) Wherein claim 1 the Encryption/Decryption means is a Public Key Infrastructure Means enabled by a suitable hardware encryption/decryption chip(s).

11) Wherein claim 1 the Encryption/Decryption means is a one time PAD enabled by suitable hardware encryption/decryption chip(s).

12) Wherein claim 1 the Encryption/Decryption means is a Virtual Matrix enabled by suitable hardware encryption/decryption chip(s).

13) Wherein claim 1 the Encryption/Decryption means is a Block Cipher enabled by a suitable hardware encryption/decryption chip(s).

14) Wherein claim 1 the Encryption/Decryption means is a Elliptical Curve enabled by a suitable hardware encryption/decryption chip(s).

15) Wherein claims 1 and 9 the Encryption/Decryption means is a quantum algorithm, such as Shor's, enabled by a suitable hardware encryption/decryption chip(s).

16) Wherein claims 1 and 9 the encyptor/decryptor ASIC and/or SOC is resident in a dongle that connects to a telephony analog to VoIP protocol transform device.

17) Wherein claim 1 the Compression/Decompression Means is G723 and all variations thereof.

18) Wherein claim 1 the Compression/Decompression Means is G729 and all variations thereof.

19) Wherein claim 1 the Compression/Decompression Means is Forward Error Correction (FEC) and all variations thereof.

20) Wherein claim 1 the Compression/Decompression Means is a Internet Low Bit Rate Codec (iLBC) and all variations thereof.

21) Wherein claim 1 the Compression/Decompression is Not Enabled by the Devices.

22) Wherein claim 1 the Encryption/Decryption is Not Enabled. by The Devices.

23) Wherein claim 1 Unique Identities are Not Known to the Devices.

24) Wherein claim 1 the wireless protocol transmission means is IEEE 802.11 and all variations thereof.

25) Wherein claim 1 the wireless protocol transmission means is IEEE 802.16 and all variations thereof.

26) Wherein claim 1 the wireless transmission frequency is specifically 600 to 800 MHz.

27) Wherein claim 1 the wireless protocol transmission means is CDMA

28) Wherein claim 1 the wireless protocol transmission means is TDMA

29) Wherein claim 1 the wireless protocol transmission means is 3G

30) Wherein claim 1 the wireless protocol transmission means is 4G

31) Wherein claim 1 the wireless transceiver and antenna are specifically vertically tuned via internal circuitry and physical antennae design to a devices known remote receiving radio antennae array to maximize range and minimize jitter and packet loss on the wireless network.

32) Wherein claim 1 the wireless transceiver and antenna are specifically horizontally tuned via internal circuitry and physical antennae design to a devices known remote receiving radio antennae array to maximize range and minimize jitter and packet loss on the wireless network.

33) Wherein claim 1 the Block Cipher is Specifically a Rijndael symmetric encryption means.

34) Wherein claims 10, 11, 12, 13, 14, 15 and 31 encryption/decryption is accomplished by suitable software and standard circuitry resident in the device.

35) An apparatus and method for securely connecting remote devices peer-to-peer over a wireless telecommunication network said apparatus and method comprising;
A signal recognition means; coupled to a signal discrimination means; coupled to a compression/decompression means; coupled to a encryption/decryption means; coupled to a unique identity means; coupled to a wireless protocol transmission means; coupled to a network protocol encapsulation means; coupled to a wireless transceiver coupled to an antenna.

36) Wherein claim 24 the remote device is connected via an USB port resident on the inventions device

37) Wherein claim 24 the remote device is connected via an IR port resident on the inventions device

38) Wherein claim 24 the remote device is connected via an RJ 45 Ethernet port resident on the inventions device

39) Wherein claim 24 the remote device is connected via a Cable port resident on the inventions device

40) Wherein claim 24 the remote device is specifically a Lap Top Computer

41) Wherein claim 24 the remote device is specifically a PDA

42) Wherein claim 24 the remote device is specifically a Computer Terminal

43) Wherein claim 24 the remote device is specifically a Cellular Phone

44) Wherein claim 24 the remote device is specifically any device resident on a LAN

45) An apparatus and method for securely connecting remote devices peer-to-peer over a wireless telecommunication network said apparatus and method comprising;
sending the unique identity of a first connecting calling device to an intended second connecting called device and obtaining from the second connecting called device the unique identity thereof.

46) Wherein claim 43 utilizing the unique identity of the second connecting called device as a public key to encrypt VOIP and Data transmissions from the first connecting calling device and utilizing the unique identity of the first connecting calling device as a public key to encrypt VOIP and Data responses from the second connecting called device.

47) Wherein claim 43 utilizing the unique identity of the second connecting called device as a Vertical Point on a Elliptical Curve to encrypt VOIP and Data transmissions from the first connecting calling device and utilizing the unique identity of the first connecting called device as a Horizontal Point on a Elliptical Curve to encrypt the VOIP and Data responses from the second connecting called device.

48) An apparatus and method for securely connecting digital phones peer-to-peer over a wireless telecommunication network said apparatus and method comprising;
a signal recognition means; coupled to a signal discrimination means; coupled to a central office switch dial tone emulation/generation means; coupled to a compression/decompression means; coupled to a encryption/decryption means; coupled to a unique identity means; coupled to a wireless protocol transmission means; coupled to a network protocol encapsulation means; coupled to a wireless transceiver coupled to an antenna.
